(19) United States
(12) Patent Application Publication
(10) Pub. No.: US 2014/0098991 A1
(43) Pub. Date: Apr. 10, 2014

(54) GAME DOLL RECOGNITION SYSTEM, RECOGNITION METHOD AND GAME SYSTEM USING THE SAME

(71) Applicant: Shu-Sian Yang, Hsin-Chu (TW)

(72) Inventor: Shu-Sian Yang, Hsin-Chu (TW)

(73) Assignee: PixArt Imaging Incorporation, R.O.C.

(21) Appl. No.: 13/648,728

(22) Filed: Oct. 10, 2012

(51) Int. Cl. G06K 9/00

(52) U.S. Cl. 382/103

(57) ABSTRACT

The present invention discloses a game doll recognition system, a recognition method, and a game system using the same. The game doll recognition system is capable of recognizing a plurality of game dolls; it includes: a data storage unit storing identification data of the game dolls; an image capturing unit capturing at least one picture of an game doll to be recognized; a processor comparing the identification data with at least a part of the picture to verify the identity of the game doll to be recognized in the picture; and a display unit showing the identity of the game doll to be recognized.

### CROSS REFERENCE

The present invention claims priority to TW 100142180, filed on Nov. 18, 2011.

### BACKGROUND OF THE INVENTION

1. Field of Invention

The present invention relates to a game doll recognition system, a recognition method, and a game system using the same, in particular to such game doll recognition system, recognition method, and game system which identify game dolls through image recognition.

2. Description of Related Art

Many characters in popular cartoons or games are made into physical dolls. However, such dolls are provided to users just for collection and appreciation, but they cannot interact with any video game system.

FIG. 1 shows a prior art game doll 10 which is identifiable by wireless communication. It is disclosed by Taiwanese Patent Publication No. M371576. As shown in FIG. 1, a sensing unit 11 capable of wirelessly transmitting data is buried in the game doll 10, and is connected to the head, hands, chest, back, and legs which may hold or wear equipments such as weapons, shields, and decorations. These parts of the body are provided with chip sensing sockets 12 for sensing the existence of corresponding equipments and electrically connected with the equipments. A game host or computer can verify the identification of the game doll 10 through wireless blue-tooth transmission.

However, although the game doll 10 is identifiable by wireless transmission, the sensing unit 11 needs to be buried in the game doll 10 during manufacture. Thus, this prior art can not be applied to numerous game dolls which have already been fabricated and collected by users. Moreover, the sensing unit 11, the wirings, and the chip sensing sockets 12 greatly increase the cost.

To recognize a game doll, a bar code label or an RF tag can be attached to the surface of the game doll. However, this requires an additional attaching process, and often the attached label or RF tag easily detaches or is contaminated, such that the doll becomes not recognizable.

In view of above, the present invention overcomes the foregoing drawbacks by providing a game doll recognition system, a recognition method, and a game system which identify game dolls through image recognition. Furthermore, by the image recognition of the present invention, the physical game doll can participate in the virtual action of a video game. That is, the physical game doll can appear in the video game as one of the virtual roles to participate in the development of the plot. A game designer can design such roles in a game to increase the interest and variation of the game.

### SUMMARY OF THE INVENTION

An objective of the present invention is to provide a game doll recognition system which identifies game dolls through image recognition.

Another objective of the present invention is to provide a recognition method for use in a game doll recognition system.

Another objective of the present invention is to provide a game system which identifies and interacts with game dolls. The physical game dolls can participate in the virtual actions of a video game. That is, the physical game doll can appear in the video game as one of the virtual roles to participate in the development of the plot. The interest and variation of the game are greatly increased.

To achieve one or more of the foregoing and other objectives, in one aspect, the present invention provides a game doll recognition system capable of recognizing a plurality of game dolls, comprising: a data storage unit for storing identification data of the game dolls, wherein the identification data are related to the images of the game dolls; an image capturing unit for capturing at least one picture of a game doll to be recognized; a processor for comparing the identification data with at least a part of the picture to verify the identity of the game doll to be recognized; and a display unit showing the identity of the game doll to be recognized.

In one embodiment, the game doll recognition system further comprises: a supporting stage supporting the game doll to be recognized to assist the image capturing unit to capture the picture; and a backdrop serving as a background of the game doll to be recognized. The supporting stage preferably includes a positioning mark indicating a position or an angle for placing the game doll to be recognized.

In one embodiment, the processor, the data storage unit, and the image capturing unit are integrated into a single device.

In one embodiment, the identification data are a plurality of images of the game dolls, and the processor compares statistic hue data of pixels of each image with statistic hue data of pixels of the picture to determine which game doll in the images is the most similar to the game doll to be recognized in the picture.

In one embodiment, the identification data are a plurality of images of the game dolls, and the processor compares a portion of the picture having a characteristic pattern with a corresponding portion of each image to determine which game doll in the images is the most similar to the game doll to be recognized in the picture.

In one embodiment, the processor compares a portion of the picture with a portion of each image according to local binary pattern, local edge pattern, scale invariant feature transformer, or edge detection.

In yet another aspect, the present invention provides a recognition method for use in the game doll recognition system, comprising: storing identification data of game dolls; capturing at least one picture of a game doll to be recognized; comparing the identification data with at least a part of the picture to verify the identity of the game doll to be recognized; and displaying the identity of the game doll to be recognized.

In yet another aspect, the present invention provides a game system capable of recognizing a game doll, comprising: at least one game doll to be recognized; a data storage unit storing identification data of a plurality of game dolls playing a plurality of roles in a game; an image capturing unit capturing at least one picture of the game doll to be recognized; a processor comparing the identification data with at least a part of the picture to verify the identity of the game doll to be recognized; and a display unit showing the identity of the game doll to be recognized.

The objectives, technical details, features, and effects of the present invention will be better understood with regard to the detailed description of the embodiments below, with reference to the drawings.

### BRIEF DESCRIPTION OF THE DRAWINGS

FIG. 1 shows a prior art game doll 10 which is identifiable by wireless communication.

FIG. 2 shows a schematic diagram of a game doll recognition system, illustrating an embodiment of the present invention.

FIG. 3 shows a page generated by the game doll recognition system after verifying the game doll.

FIG. 4 shows a schematic diagram of a game doll recognition system embodied as a hand-held game device, illustrating another embodiment of the present invention.

FIG. 5 shows a picture of a game doll to be recognized, illustrating an embodiment of the present invention.

FIG. 6A shows a statistic diagram of the hues appearing in the picture of a game doll to be recognized in accordance with an embodiment of the present invention.

FIG. 6B shows a statistic diagram stored in a data storage unit in accordance with an embodiment of the present invention.

FIG. 7A shows the hues of a pixel and its adjacent pixels in a portion of the picture of a game doll to be recognized in accordance with an embodiment of the present invention.

FIG. 7B corresponds to FIG. 7A wherein each outer pixel is assigned a representative value after it is compared with the center pixel.

FIG. 8 shows a statistic diagram of the representative values representing pixels of a partial picture of a game doll to be recognized in accordance with an embodiment of the present invention.

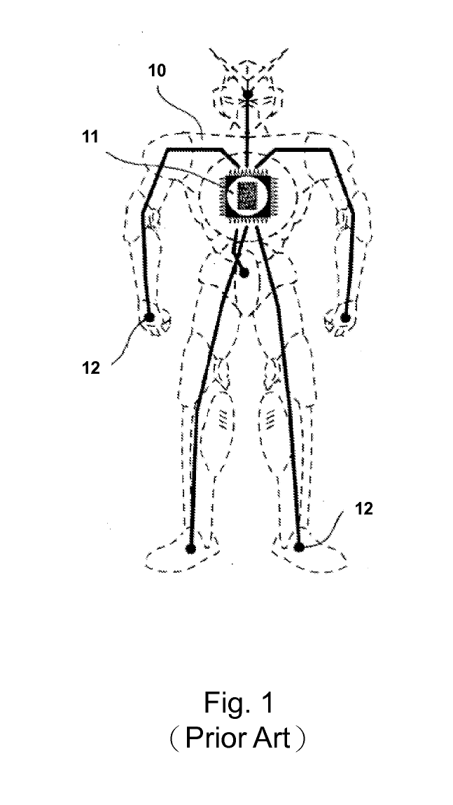

### DESCRIPTION OF THE PREFERRED EMBODIMENTS

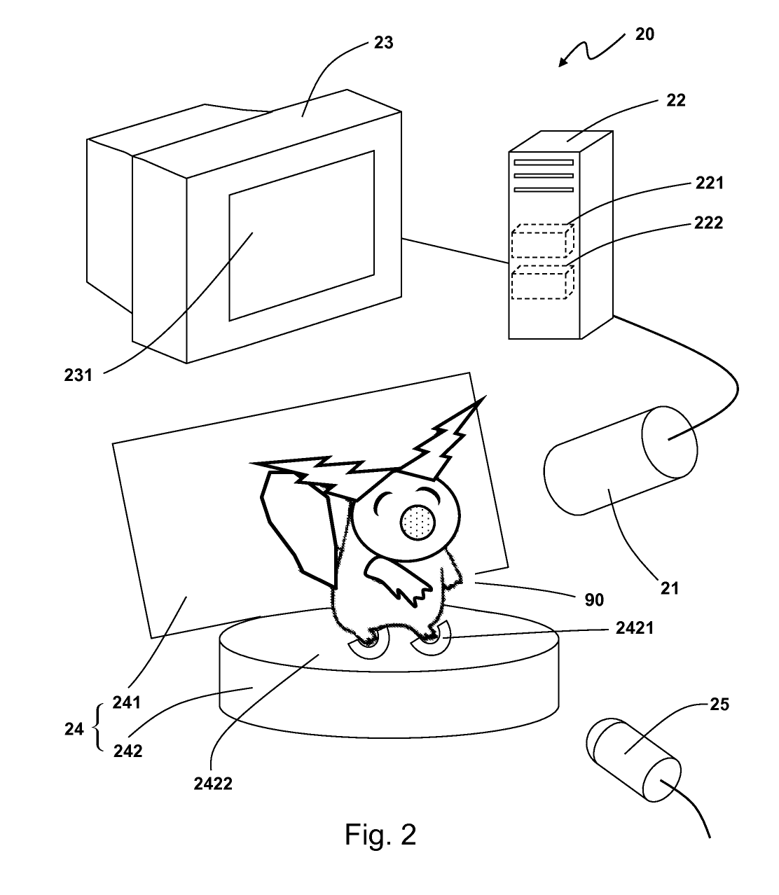

FIG. 2 shows a schematic diagram of a game doll recognition system illustrating an embodiment of the present invention. The game doll recognition system 20 comprises an image capturing unit 21, a game host 22, a display 23, and a supporting stage 24. A game doll 90 is placed on the supporting stage 24 in front of the image capturing unit 21, and one or more positioning mark 2421 are provided on the supporting stage 242 to assist positioning the game doll 90 so that the image capturing unit 21 can better capture a picture of the game doll 90. Preferably, a backdrop 241 is placed behind the supporting stage 242 to avoid capturing objects after the game doll 90 which are unwanted, such that the image recognition of the game doll 90 can be more accurate. Certainly, the supporting stage 24 and the backdrop 241 can be omitted if the accuracy of the image recognition is already acceptable. The supporting stage 242 preferably has a platform 2422 having an adjustable height, and the game doll 90 can stand on the platform 2422. When the platform 2422 is lowered, preferably, a background shelter (not shown) behind the supporting stage 24 appears. The background shelter is similar to the backdrop 241 in its structure and function, and it extends below the backdrop 241 in this figure.

The game doll recognition system 20 preferably comprises a light source 25. It emits light which is projected on the game doll to be recognized 90, so the image capturing unit 21 can receive the light reflected by the game doll 90. Preferably, the image capturing unit 21 further captures a certain scene. The captured scene, or a pre-stored scene is reproduced on the screen 231, so that the user feels as if he is right in the scene.

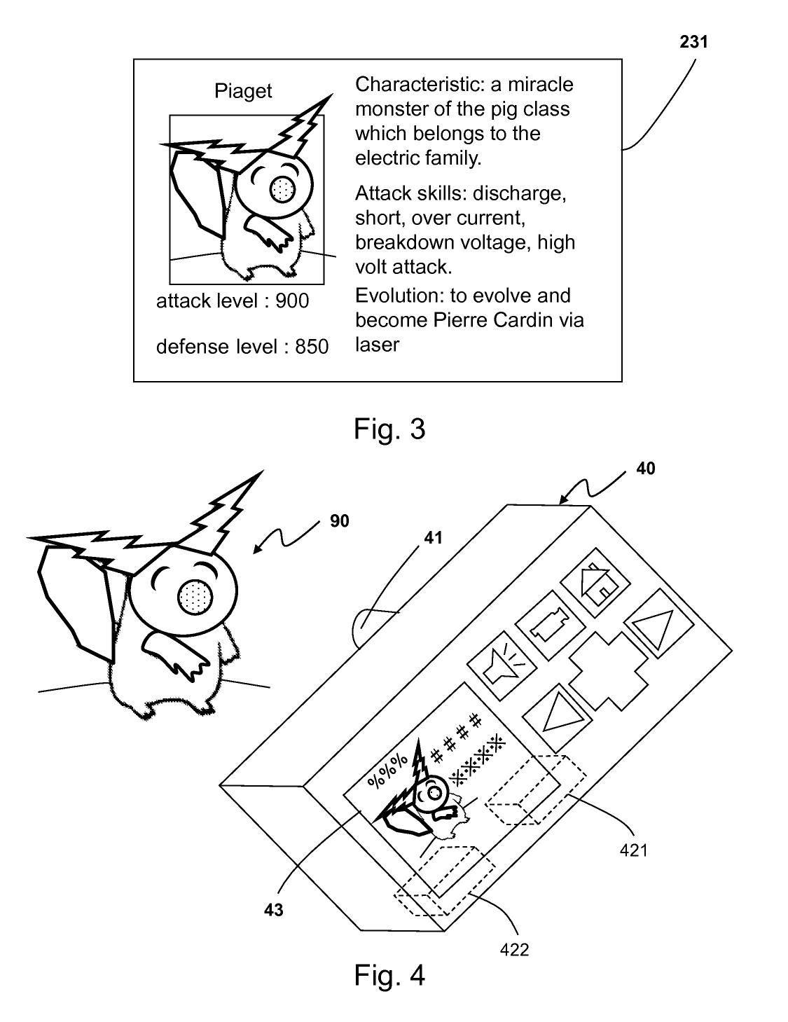

The image capturing unit 21 captures at least one picture including an image of the game doll 90. The processor 221 of the game host 22 can recognize the identity of the game doll 90. The data storage unit 222 (e.g., memory, hard disc or the like) of the game host 22 has pre-stored an image database of images of various game dolls and their corresponding identities and related information. The processor 221 compares the picture of the game doll 90 with images in the image database stored to recognize the game doll 90, that is, to determine which game doll in the image database is the most similar to the game doll 90 in the picture. In addition, the image, the corresponding identities, and/or related information of the most similar one can be shown as a page 231 on the display 23, such that the user can review the recognition result and the information of the game doll 90, as shown in FIG. 3. During the comparison process of the foregoing image recognition, the whole or apart of the picture of the game doll 90 having a distinctive characteristic pattern is compared with the image of each game doll in the image database. Examples for such an image comparison process will be described below, but the present invention is not limited to the described examples and the image comparison can be done by other methods. The image database, corresponding identities, and/or related information of various game dolls stored in the data storage unit 222 are referred to as identification data.

The image capturing unit 21 may be a CMOS image sensing device or a CCD image sensing device. The processor and the data storage unit can be integrated into the image capturing unit, and the image capturing unit outputs the result of the image recognition to the display. In other embodiments, the user can read the result in other manners.

FIG. 4 shows a schematic diagram of a game doll recognition system embodied as a hand-held game device, illustrating another embodiment of the present invention. The hand-held game device 40 comprises an image capturing unit 41, a processor 421, a data storage unit 422, and an LCD (liquid crystal display) 43. The image recognition and the display of the recognition result can be performed by one single hand-held game device 40. The hand-held game device 40 for example may be a mobile phone with a camera. The image recognition can be executed by installed software or by a remote server through internet. The user can proceed the game after reading the recognition result displayed by the LCD 43. For example, the user can join a team to fight a campaign with his game doll, or start a campaign against an opponent. Certainly, the page of the recognition result also can be shown on an external display unit or a TV screen. The user can designate another game doll to replace the current game doll according to his desire or the request or option of the game, and puts the designated game doll before the image capturing unit 41 for capturing the image of the new game doll. The game doll can accordingly be determined to act as the current contestant. The game and the playing method can be designed in various ways, not limited to the examples given above. The processor 421 can execute the game program and control the proceedings of the game in light of the inputs from the user and the image capturing unit 41.

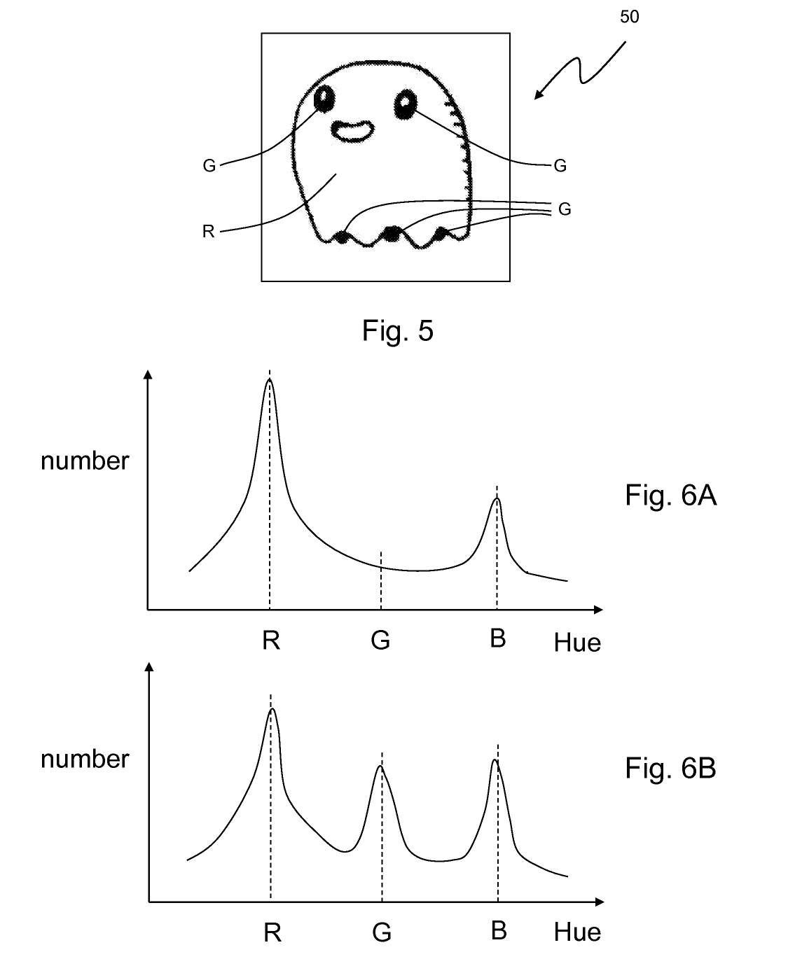

FIG. 5 shows a picture of an game doll to be recognized, illustrating an embodiment of the present invention. The picture 50 captured by the image capturing unit 21 includes red pixels R and green pixels G, and the rest portions and the background are white. The hues of all pixels of the picture 50 are statistically calculated, and hence, a statistic bar chart diagram in FIG. 6A is obtained which illustrates the statistic quantities of hues. Among the hues, certain ones such as red, green, and blue can be selected as the objects for comparison. That is, not all hues need to be statistically calculated for comparison.

FIG. 6B shows a statistic diagram stored in the data storage unit 422, which illustrates the statistic quantities of hues appearing in the image of a pre-stored game doll. In one embodiment, the comparison can be performed as follows. The statistic quantity of each hue in FIG. 6A is multiplied by the statistic quantity of each corresponding hue in FIG. 6B. The products of them can be summed to obtain a similarity index. In a similar way, the statistic quantity of each hue in FIG. 6A is multiplied by the statistic quantity of each corresponding hue of other game doll images stored in the data storage unit 422, and the products of them can be summed to obtain a similarity index for each pre-stored game doll image. As shown by FIG. 6A and FIG. 6B, when the two statistic diagrams are more similar to each other, the similarity index obtained by adding the products is larger. Therefore, the processor designates the identity of one game doll in the images which has the largest similarity index as the identity of the current game doll to be recognized. The identity or the related information of this game doll is read from the data storage unit, and is outputted to the display unit, as shown in FIG.

In the foregoing embodiment the whole picture is analyzed as the object of the image recognition. In another embodiment, the processor can compare a portion of the picture which has a distinctive characteristic pattern with a corresponding portion of each game doll image in the database. The comparison can be performed according to hues as described in the above, or according to local binary pattern, local edge pattern, scale invariant feature transformer, or edge detection, to obtain an index of similarity.

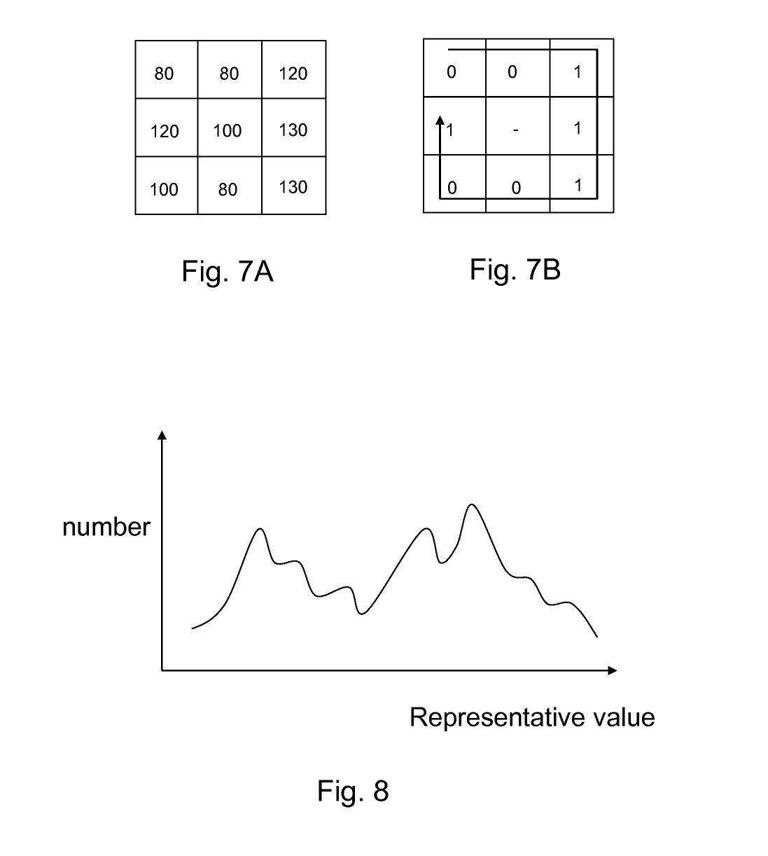

For example, the image including two protrusive ears of the game doll 90 can be selected from the picture, and the partial picture can be taken as the object for the image recognition. The image recognition can be performed according to the above-described method, but as an example, another calculation method for comparison can be taken according to the position relations of adjacent pixels in the selected portion of the picture. Because the position relations of the adjacent pixels are taken into the calculation, different images with the same statistical quantities of hues can be distinguishable. FIG. 7A shows the hues of a pixel and its adjacent pixels in a portion of the picture of a game doll to be recognized, that is, a portion of the game doll is sufficient to be recognized. FIG. 7B shows a calculation result wherein each outer pixel is assigned a representative value after it is compared with the center pixel. After the hues of the outer 8 pixels in FIG. 7A are respectively compared with the hue of the center pixel, the result value is given as 1 if the hue of the outer pixel is larger than that of the center pixel, as shown in FIG. 7B. A binary value 00111001 is obtained according to the arrow direction in FIG. 7B, and it is converted into a decimal value 78. Each pixel of the partial picture of the game doll to be recognized is processed by the foregoing operation, and a binary value or a decimal value is obtained to represent the pixel. The number of pixels having the same decimal value is statistically counted, to obtain a bar chart as shown by FIG. 8. In addition, the corresponding partial image of each game doll stored in the data storage unit can be processed according to the foregoing method to obtain a statistic chart. Then, the representative values of the partial picture of the game doll to be recognized are compared with the representative values of the corresponding partial image of each game doll, to check the statistical similarity. As an example, the aforementioned comparison method by means of calculating similarity indices may be adopted here, but other comparison methods can be used as well. Thus, the identity of the current game doll to be recognized is verified.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, the processor, the data storage unit, the image capturing unit, and the display unit may be all integrated into a single device, or some of them may be integrated into one unit but not the others. Thus, the present invention should cover all such and other modifications and variations, which should be interpreted to fall within the scope of the following claims and their equivalents.

What is claimed is:

1. A game doll recognition system capable of recognizing a plurality of game dolls, comprising:
a data storage unit for storing identification data of the game dolls, wherein the identification data are related to the images of the game dolls;
an image capturing unit for capturing at least one picture of at least a portion of a game doll to be recognized;
a processor for comparing the identification data with at least a part of the picture to verify the identity of the game doll to be recognized; and
a display unit showing the identity of the game doll to be recognized.

2. The game doll recognition system of claim 1, further comprising a supporting stage for supporting the game doll to be recognized to assist the image capturing unit to capture the picture.

3. The game doll recognition system of claim 2, wherein the supporting stage includes a positioning mark indicating a position or an angle for placing the game doll to be recognized.

4. The game doll recognition system of claim 2, wherein the supporting stage includes a platform for supporting the game doll to be recognized, and the platform has a height which is adjustable.

5. The game doll recognition system of claim 4, wherein the supporting stage further includes a background shelter appearing when the platform is descended.

6. The game doll recognition system of claim 1, further comprising: a light source emitting light on the game doll to be recognized, wherein the image capturing unit receives the light reflected by the game doll.

7. The game doll recognition system of claim 1, wherein the image capturing unit further captures a scene image.

8. The game doll recognition system of claim 2, further comprising a backdrop serving as a background of the game doll to be recognized in the picture.

9. The game doll recognition system of claim 1, further comprising: a host including the processor and the data storage unit, the host outputting the identity of the game doll to be recognized to the display unit.

10. The game doll recognition system of claim 1, wherein the processor, the data storage unit, and the image capturing unit are integrated into a single device.

11. The game doll recognition system of claim 1, wherein the identification data are the images of the game dolls, and the processor compares statistic hue data of pixels of each image with statistic hue data of pixels of the picture to determine which game doll in the images is the most similar to the game doll to be recognized in the picture.

12. The game doll recognition system of claim 11, wherein the processor compares a portion of the picture having a characteristic pattern with a portion of each image to determine which game doll in the images is the most similar to the game doll to be recognized in the picture.

13. The game doll recognition system of claim 12, wherein the processor compares the portion of the picture with the portion of each image according to local binary pattern, local edge pattern, scale invariant feature transformer, or edge detection.

14. A recognition method for use in a game doll recognition system, comprising:
storing identification data of game dolls;
capturing at least one picture of at least a portion of a game doll to be recognized;
comparing the identification data with at least a part of the picture to verify the identity of the game doll to be recognized; and
displaying the identity of the game doll to be recognized.

15. The recognition method for use in the game doll recognition system of claim 14, further comprising a step of indicating a position or an angle for placing the game doll to be recognized.

16. The recognition method for use in the game doll recognition system of claim 14, wherein the identification data are the images of the game dolls, and the step of comparing the identification data with at least a part of the picture to verify the identity of the game doll to be recognized comprises: comparing statistic hue data of pixels of each image with statistic hue data of pixels of the picture to determine which game doll in the images is the most similar to the game doll to be recognized in the picture.

17. The recognition method for use in the game doll recognition system of claim 14, wherein the identification data are the images of the game dolls, and the step of comparing the identification data with at least a part of the picture to verify the identity of the game doll to be recognized comprises: comparing a portion of the picture having a characteristic pattern with a corresponding portion of each image to determine which game doll in the images is the most similar to the game doll to be recognized in the picture.

18. The recognition method for use in the game doll recognition system of claim 17, wherein the portion of the picture is compared with the portion of each image according to local binary pattern, local edge pattern, scale invariant feature transformer, or edge detection.

19. A game system capable of recognizing a game doll, comprising:
at least one game doll to be recognized;
a data storage unit storing identification data of a plurality of game dolls playing a plurality of roles in a game;
an image capturing unit capturing at least one picture of the game doll to be recognized;
a processor comparing the identification data with at least a part of the picture to verify the identity of the game doll to be recognized; and
a display unit showing the identity of the game doll to be recognized.

20. The game system capable of recognizing a game doll of claim 19, further comprising a supporting stage supporting the game doll to be recognized to assist the image capturing unit to capture the picture.

21. The game system capable of recognizing a game doll of claim 20, wherein the supporting stage includes a positioning mark indicating a position or an angle for placing the game doll to be recognized.

22. The game system capable of recognizing a game doll of claim 20, wherein the supporting stage includes a platform for supporting the game doll to be recognized, and the platform has a height which is adjustable.

23. The game system capable of recognizing a game doll of claim 19, further comprising: a host including the processor and the data storage unit, the host outputting the identity of the game doll to be recognized to the display unit.

24. The game system capable of recognizing a game doll of claim 19, wherein the processor, the data storage unit, and the image capturing unit are integrated into a single device.

25. The game system capable of recognizing a game doll of claim 19, wherein the identification data are the images of the game dolls, and the processor compares statistic hue data of pixels of each image with statistic hue data of pixels of the picture to determine which game doll in the images is the most similar to the game doll to be recognized in the picture.

26. The game system capable of recognizing a game doll of claim 19, wherein the processor compares a portion of the picture having a characteristic pattern with a corresponding portion of each image to determine which game doll in the images is the most similar to the game doll to be recognized in the picture

27. The game system capable of recognizing a game doll of claim 26, wherein the processor compares the portion of the picture with the portion of each image according to local binary pattern, local edge pattern, scale invariant feature transformer, or edge detection.
